(19) United States
(12) Patent Application Publication
(10) Pub. No.: US 2025/0269959 A1
(43) Pub. Date: Aug. 28, 2025

(54) SYSTEMS AND METHODS FOR PERFORMING AN AGRICULTURAL SPRAYING OPERATION

(71) Applicant: CNH Industrial America LLC, New Holland, PA (US)

(72) Inventor: Jamil Farhat, Spicer, MN (US)

(21) Appl. No.: 19/063,704

(22) Filed: Feb. 26, 2025

Related U.S. Application Data
(60) Provisional application No. 63/558,357, filed on Feb. 27, 2024.

(51) Int. Cl. B64D 1/18; A01C 21/00; A01C 23/00; A01C 23/04; A01M 7/00; G05D 1/648; G05D 107/20; G05D 109/20

(52) U.S. Cl. CPC B64D 1/18; A01C 21/005; A01C 23/007; A01C 23/047; A01M 7/0032; A01M 7/0089; G05D 1/6482; G05D 2107/21; G05D 2109/20

(57) ABSTRACT

A method for performing an agricultural spraying operation with an agricultural applicator includes receiving, with a computing system, data indicative of a field having a no-spray zone between spray zones, with the spray zones including a first spray zone and a second spray zone. The method further includes generating, with the computing system, a flight plan for an agricultural applicator based at least in part on the data indicative of the field, where the agricultural applicator is an unmanned aerial vehicle (UAV) having an applicator tank for holding agricultural product configured to be dispensed within the spray zones, and where the flight plan includes at least one pass extending from the first spray zone across the no-spray zone to the second spray zone. Additionally, the method includes controlling, with the computing system, the UAV to perform the flight plan.

### CROSS REFERENCE TO RELATED APPLICATION

The present application is based upon and claims the right of priority to U.S. Provisional Patent Application No. 63/558,357 filed on Feb. 27, 2024, the entirety of which is incorporated by reference herein for all purposes.

### FIELD

The present disclosure generally relates to agricultural applicators and, more particularly, to systems and methods for performing agricultural spraying operations within a field with such agricultural applicators.

### BACKGROUND

Agricultural applicators or sprayers apply an agricultural product (e.g., an herbicide, fertilizer, fungicide, a pesticide, or another product) onto crops and/or a ground surface as the sprayer is traveling proximate to a field. In some instances, the sprayer can support one or more nozzle assemblies. Each nozzle assembly has a valve configured to control the spraying of the agricultural product through a nozzle onto underlying targets, which may include crops, weeds, a ground surface, and/or any other object. In some instances, the agricultural sprayer may be an unmanned aerial vehicle (UAV). For example, UAVs may be flown across a field to apply agricultural product to the targets.

As such, systems and methods for performing an agricultural spraying operation with such agricultural applicators would be welcomed in the technology.

### BRIEF DESCRIPTION

Aspects and advantages of the technology will be set forth in part in the following description, or may be obvious from the description, or may be learned through practice of the technology.

In one aspect, the present subject matter is directed to a method for performing an agricultural spraying operation. The method may include receiving, with a computing system, data indicative of a field having a no-spray zone between spray zones, the spray zones including a first spray zone and a second spray zone. The method may further include generating, with the computing system, a flight plan across the field for an agricultural applicator based at least in part on the data indicative of the field, where the agricultural applicator may be configured as an unmanned aerial vehicle (UAV) having an applicator tank for holding agricultural product configured to be dispensed within the spray zones, and where the flight plan may include at least one pass extending from the first spray zone across the no-spray zone to the second spray zone. Additionally, the method may include controlling, with the computing system, the UAV to perform the flight plan.

In some aspects, the present subject matter is directed to a system for performing an agricultural spraying operation. The system may include an agricultural applicator configured as an unmanned aerial vehicle (UAV), where the UAV may have an applicator tank for holding agricultural product. The system may further include a computing system communicatively coupled to the UAV. The computing system may be configured to receive data indicative of a field having a no-spray zone between spray zones, the spray zones including a first spray zone and a second spray zone. The computing system may additionally be configured to generate a flight plan across the field for the UAV based at least in part on the data indicative of the field, where the UAV may be configured to dispense the agricultural product within the spray zones when following the flight plan, and where the flight plan may include at least one pass extending from the first spray zone across the no-spray zone to the second spray zone.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a schematic view of a system with various agricultural applicators and a base station in accordance with aspects of the present subject matter;

FIG. 2 illustrates a block diagram of various components of the system of FIG. 1 in accordance with aspects of the present subject matter;

FIGS. 3A-3B illustrate example route plans for use with the system of FIGS. 1 and 2 in accordance with aspects of the present subject matter; and

FIG. 4 illustrates a flow diagram of one embodiment of a method for performing an agricultural spraying operation with agricultural applicators in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

As used throughout this disclosure, the term “autonomous” refers to a vehicle capable of implementing at least one operation without driver input. An “operation” refers to a change in one or more of the steering, braking, acceleration/deceleration of the vehicle, actuation of a component of an implement, actuation of a component of a trailer, and/or actuation of any other component of the vehicle and/or any assembly operably coupled with the vehicle. The term “semi-autonomous” refers to a vehicle capable of implementing at least one operation that is not fully automatic but assists the operator with such operation (e.g., fully operational without a driver or driver input). As such an autonomous vehicle includes those that can operate under operator control during certain time periods and without operator control during other time periods while a semi-autonomous vehicle includes those that can operate under operator control during certain time periods and assist with operator control during other time periods.

In general, the present subject matter is directed to systems and methods for performing agricultural spraying operations with agricultural applicators, particularly agricultural applicators configured as UAVs. Specifically, in several embodiments, a UAV may have an applicator tank for holding an agricultural product to be dispensed by the agricultural applicator onto a field. A computing system may receive a field map for a field having at least one no-spray zone between two spray zones, where the agricultural product may be sprayed in the spray zones but may not be sprayed in the no-spray zone(s) (e.g., to reduce agricultural product runoff, to reduce wasted product in non-planting areas, and/or the like). The computing system may generate a flight plan or path that guides the agricultural applicator across the most efficient path across the spray zones. Particularly, the flight plan may minimize the number of turns for flying across the different spray zones by including flight plan portions from one spray zone through the no-spray zone(s) to another spray zone. In some instances, the computing system may also generate application instructions, where the application instructions control the agricultural applicator to perform spraying operations while flying the flight plan, where the application instructions may be used to control the applicator to spray when flying in the spray zones and to not spray when flying in the no-spray zones. As such, the flight plan and related application instructions generated by the computing system significantly reduce the amount of time for performing an agricultural spraying operation with UAVs, while improving compliance with no-spray zones.

While the vehicles described below are generally illustrated and described as UAVs configured to perform a spraying operation, it will be appreciated that the UAVs may be configured to perform at least one of a planting process, a seeding process, and/or any other process in which a product is dispensed, and optionally, a mapping process, a scouting process, and/or the like. In addition, it will be appreciated that the UAVs may be human-controlled, autonomously controlled, and/or semi-autonomously controlled without departing from the teachings provided herein.

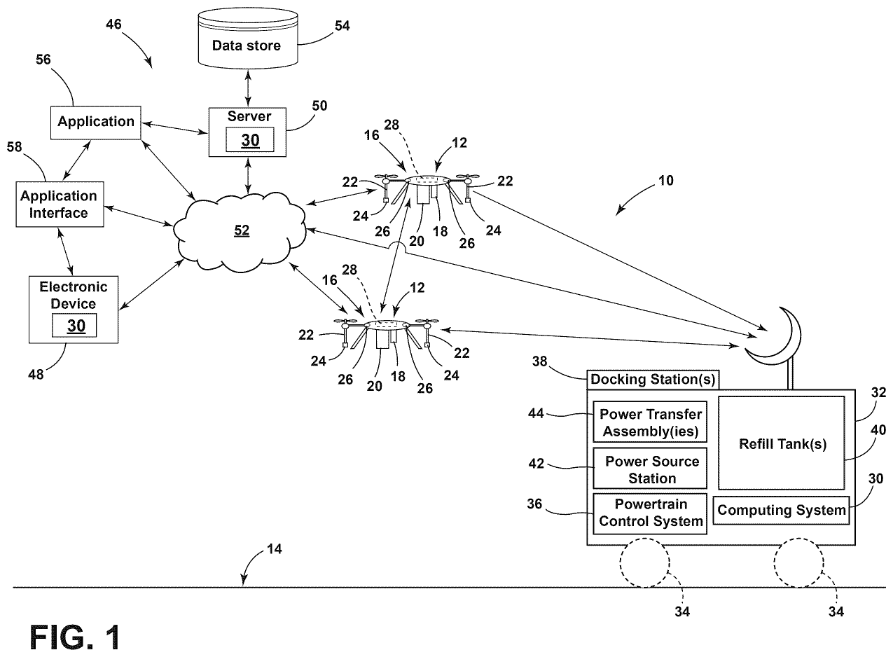

Referring now to FIG. 1, a system 10 for an agricultural operation is illustrated in accordance with aspects of the present subject matter. As shown in FIG. 1, the system may generally include one or more unmanned aerial vehicles (UAVs) 12 configured to be flown over a field 14 to perform one or more operations. For instance, the UAVs 12 may be configured to dispense an agricultural product (e.g., an herbicide, fertilizer, fungicide, pesticide, or another product) onto the underlying field, collect data associated with one or more objects within the field, collect data associated with a topology for the field, and/or perform any other operation.

Each UAV 12 can include a propulsion system 16 that generates movement of the UAV. The propulsion system 16 may be powered by a power source, such as a battery 18, that is operably coupled with the UAV 12. As such, the propulsion system 16 of the UAV 12 may allow the UAV to perform controlled vertical, or nearly vertical, takeoffs and landings. For instance, in the illustrated embodiment, each of the UAVs 12 corresponds to a quadcopter in which the propulsion system powers each of four rotors to maneuver the vehicle. However, in other embodiments, one or more of the UAVs 12 may correspond to any other multi-rotor aerial vehicle, such as a tricopter, hexacopter, or octocopter. In still further embodiments, one or more of the UAVs 12 may be a single-rotor helicopter, or a fixed-wing, hybrid vertical takeoff, and landing aircraft. Still further, it will be appreciated that the UAV(s) 12 may be implemented as any other manned or unmanned vehicle, or combination of types of vehicles, capable of performing any of the functions described herein through operator input, semi-autonomously, and/or autonomously without departing from the scope of the present disclosure.

Each of the UAVs 12 may also include a product tank 20. The product tank 20 is generally configured to store or hold an agricultural product, such as an herbicide, fertilizer, fungicide, pesticide, or another product. The agricultural product is conveyed from the product tank 20 through a product circuit including plumbing components 22, such as interconnected pieces of tubing, for release onto the underlying field (e.g., plants and/or soil) through one or more nozzle assemblies 24. Each nozzle assembly 24 may include, for example, a spray nozzle and an associated valve for regulating the flow rate of the agricultural product through the nozzle (and, thus, the application rate of the nozzle assembly), thereby allowing the desired spray characteristics of a spray fan of the agricultural product expelled from the nozzle to be achieved. In some instances, each valve may be selectively activated to direct an agricultural product towards a defined target. For instance, each valve may be selectively activated to deposit a suitable herbicide toward a detected/identified weed and/or a nutrient toward a detected/identified crop.

In several embodiments, the UAV(s) 12 may include one or more sensors 26 to collect data associated with the UAV, an additional UAV, one or more objects within the field 14, a topology for the field 14, and/or any other information. For instance, the UAV(s) 12 may selectively activate one or more nozzle assemblies to deposit a suitable herbicide toward a detected/identified weed and/or a nutrient toward a detected/identified crop based on data from the one or more sensors. In some examples, the sensors 26 can include one or more spray sensors, orientation sensors, pressure sensors, propulsion sensors, energy sensors, a weather station, and/or any other sensing assembly. For instance, suitable spray sensors (e.g., an imaging sensor, a LIDAR, a RADAR, or any other suitable type of sensor) may be configured to capture data related to the one or more spray fans. Similarly, suitable orientation sensors (e.g., an imaging sensor, a LIDAR, a RADAR sensor, a Hall effect sensor, a gyroscope sensor, a magnetometer sensor, an accelerometer sensor, a yaw-rate sensor, a piezoelectric sensor, a position sensor, a complementary metal-oxide-semiconductor (CMOS) sensor, a pressure sensor, a capacitive sensor, an ultrasonic sensor, or any other suitable type of sensor) may be configured to capture data related to a position, angle, displacement, distance, speed, acceleration of the UAV. Suitable pressure sensors (e.g., a diaphragm pressure sensor, a piston pressure sensor, a strain gauge-based pressure sensor, an electromagnetic pressure sensor, or any other suitable type of sensor) may be configured to capture data indicative of the pressure of the agricultural product being supplied to or through the nozzle assemblies 24. Suitable propulsion sensors may be configured to capture data related to one or more components of the propulsion system. Suitable energy sensors may be configured to capture data related to an amount of usable energy for the UAV. In examples in which the sensor(s) 26 corresponds to or includes a camera, a single-spectrum camera or a multi-spectrum camera may be implemented and configured to capture image data, for example, in the visible light range and/or infrared spectral range. Additionally, in various embodiments, the cameras may correspond to a single lens camera configured to capture two-dimensional image data or a stereo cameras having two or more lenses with a separate image imaging device for each lens to allow the cameras to capture stereographic or three-dimensional image data.

In addition, the UAVs 12 may also support one or more additional components, such as an on-board computing device 28. In general, the UAV computing device 28 may be configured to control the operation of the UAV 12, such as by controlling the propulsion system 16 of the UAV to cause the UAV to be moved relative to the field 14. For instance, in some embodiments, the UAV computing device 28 may be configured to receive flight plan data associated with a proposed flight plan for the associated UAV 12, such as a flight plan selected such that the UAV makes one or more passes across the field 14 in a manner that allows the agricultural product to be applied to a defined target. Based on such data, the UAV computing device 28 may control the operation of the UAV 12 such that the UAV is flown across the field 14 according to the proposed flight plan.

Additionally, as shown in FIG. 1, the system 10 may also include one or more remote computing systems 30 separate from or remote to the UAVs 12. In several embodiments, the remote computing system(s) 30 may be communicatively coupled to the UAV computing device(s) 28 to allow data to be transmitted between the UAV(s) 12 and the remote computing system(s). For instance, in various embodiments, the remote computing system(s) 30 may be configured to transmit instructions or data to the UAV computing device(s) 28 that is associated with the flight plan across the field 14. Similarly, the UAV computing device(s) 28 may be configured to transmit or deliver the data collected by the sensor(s) 26 to the remote computing system(s) 30.

The remote computing system(s) 30 may correspond to a stand-alone component or may be incorporated into or form part of a separate component or assembly of components. For example, in various embodiments, the remote computing system(s) 30 may form part of a base station 32. In such an embodiment, the base station 32 may be portable, such as by being transportable to a location within or near the field 14, or the base station 32 may be disposed at a fixed location, such as a farm building or central control center, which may be proximal or remote to the field 14. In instances in which the base station 32 is portable, the base station may include one or more base station wheels 34. The one or more base station wheels 34 may be configured to support the base station 32 relative to the field. In some embodiments, the base station 32 may also include a powertrain control system 36 that may include a power plant, such as an engine, a motor, or a hybrid engine-motor combination, a transmission or hydraulic propel system configured to transmit power from the power plant to the one or more base station, and/or a brake system.

As shown in FIG. 1, in various embodiments, the base station 32 may further include various systems and components for supporting the UAVs 12. For instance, the base station 32 may include a docking station 38, which may be positioned on a top portion of the base station and/or at any other location. The base station 32 may further include one or more refill tanks 40 and/or a power source station 42. The refill tank(s) 40 may be configured to store additional agricultural products, a rinse fluid, and/or any other fluid that may be transferred to the UAVs 12, such as when the UAV(s) is located on the docking station. The power source station 42 may store one or more power sources, such as one or more batteries (e.g., battery 18), that may be operably couplable with the UAV 12. In some instances, the power sources may be transferred from the power source station to the docking station (or any other location) through a power transfer assembly 44 such that the power source within a UAV 12 may be replaced and/or refilled with supplemental energy. In some instances, instead of, or in addition to, the UAVs 12 using replaceable and/or rechargeable batteries 18, the UAVs may run on other fuels (e.g., gasoline, diesel, hydrogen, etc.), in which case the power source station 42 may store such other fuels and the transfer assembly 44 may be used to replace/refill tank(s) on the UAVs 12 for storing such other fuels.

With further reference to FIG. 1, in other embodiments, the one or more remote computing systems may correspond to or form part of a remote cloud-based system 46. For instance, the UAV(s) 12, the base station 32, and/or an electronic device 48 may be communicatively coupled with one another and/or one or more remote sites, such as a remote server 50 via a network/cloud 52 to provide data and/or other information therebetween. The network/cloud 52 represents one or more systems by which the UAV(s) 12, the base station 32, and/or the electronic device 48 may communicate with the remote server 50. The network/cloud 52 may be one or more of various wired or wireless communication mechanisms, including any desired combination of wired and/or wireless communication mechanisms and any desired network topology (or topologies when multiple communication mechanisms are utilized). Example communication networks 52 include wireless communication networks (e.g., using Bluetooth, IEEE 802.11, etc.), local area networks (LAN), and/or wide area networks (WAN), including the Internet and the Web, which may provide data communication services and/or cloud computing services. The Internet is generally a global data communications system. It is a hardware and software infrastructure that provides connectivity between computers. In contrast, the Web is generally one of the services communicated via the Internet. The Web is generally a collection of interconnected documents and other resources, linked by hyperlinks and URLs. In many technical illustrations when the precise location or interrelation of Internet resources are generally illustrated, extended networks such as the Internet are often depicted as a cloud (e.g. 52 in FIG. 1). The verbal image has been formalized in the newer concept of cloud computing. The National Institute of Standards and Technology (NIST) defines cloud computing as “a model for enabling convenient, on-demand network access to a shared pool of configurable computing resources (e.g., networks, servers, storage, applications, and services) that can be rapidly provisioned and released with minimal management effort or service provider interaction.” Although the Internet, the Web, and cloud computing are not the same, these terms are generally used interchangeably herein, and they may be referred to collectively as the network/cloud 52.

The server 50 may be one or more computing devices, each of which may include at least one processor and at least one memory, the memory storing instructions executable by the processor, including instructions for carrying out various steps and processes. The server 50 may include or be communicatively coupled to a data store 54 for storing collected data as well as instructions for the UAV(s) 12, the base station 32, and/or the electronic device 48 with or without intervention from a user, the UAV(s) 12, the base station 32, and/or the electronic device 48. Moreover, the server 50 may be capable of analyzing initial or raw sensor data received from the UAV(s) 12, the electronic device 48, and/or the base station 32, and final or post-processing data (as well as any intermediate data created during data processing). Accordingly, the instructions provided to any one or more of the UAV(s) 12, the base station 32, and/or the electronic device 48 may be determined and generated by the server 50 and/or one or more cloud-based applications 56. In such instances, a user interface for the UAV(s) 12, a user interface for the base station 32, and/or the electronic device 48 may be a dummy device that provides various notifications based on instructions from the network/cloud 52.

With further reference to FIG. 1, the server 50 also generally implements features that may enable the UAV(s) 12, the base station 32, and/or the electronic device 48 to communicate with cloud-based applications 56. Communications from the electronic device 48 can be directed through the network/cloud 52 to the server 50 and/or cloud-based applications 56 with or without a networking device, such as a router and/or modem. Additionally, communications from the cloud-based applications 56, even though these communications may indicate the UAV(s) 12, the base station 32, and/or the electronic device 48 as an intended recipient, can also be directed to the server 50. The cloud-based applications 56 are generally any appropriate services or applications 56 that are accessible through any part of the network/cloud 52 and may be capable of interacting with the electronic device 48.

In various examples, the UAV(s) 12, the base station 32, and/or the electronic device 48 can be feature-rich with respect to communication capabilities, i.e. have built-in capabilities to access the network/cloud 52 and any of the cloud-based applications 56 or can be loaded with, or programmed to have, such capabilities. The UAV(s) 12, the base station 32, and/or the electronic device 48 can also access any part of the network/cloud 52 through industry-standard wired or wireless access points, cell phone cells, or network nodes. In some examples, users can register to use the remote server 50 through the UAV(s) 12, the base station 32, and/or the electronic device 48, which may provide access to the UAV(s) 12, the base station 32, and/or the electronic device 48 and/or thereby allow the server 50 to communicate directly or indirectly with the UAV(s) 12, the base station 32, and/or the electronic device 48. In various instances, the UAV(s) 12, the base station 32, and/or the electronic device 48 may also communicate directly, or indirectly, with others of the UAV(s) 12, the base station 32, and/or the electronic device 48, or one of the cloud-based applications 56 in addition to communicating with or through the server 50. According to some examples, the UAV(s) 12, the base station 32, and/or the electronic device 48 can be preconfigured at the time of manufacture with a communication address (e.g. a URL, an IP address, etc.) for communicating with the server 50 and may or may not have the ability to upgrade or change or add to the preconfigured communication address.

Referring still to FIG. 1, when a new cloud-based application 56 is developed and introduced, the server 50 can be upgraded to be able to receive communications for the new cloud-based application 56 and to translate communications between the new protocol and the protocol used by the UAV(s) 12, the base station 32, and/or the electronic device 48. The flexibility, scalability, and upgradeability of current server technology render the task of adding new cloud-based application protocols to the server 50 relatively quick and easy.

In several embodiments, an application interface 58 may be operably coupled with the cloud 52 and/or the application 56. The application interface 58 may be configured to receive data related to the UAV(s) 12, the base station 32, and/or the electronic device 48. In various embodiments, one or more inputs related to the field data may be provided to the application interface 58. For example, a farmer, a vehicle user, a company, or other persons may access the application interface 58 to enter the inputs related to the field data. Additionally, or alternatively, the inputs related to the field data may be received from the remote server 50. For example, the inputs related to the field data may be received in the form of software that can include one or more objects (e.g., crops (crop rows, etc.), weeds, landmarks, targets, and/or the like within the field 14), agents, lines of code, threads, subroutines, databases, application programming interfaces (APIs), or other suitable data structures, source code (human-readable), object code (machine-readable). In response, the application 56 may update any input/output based on the received inputs. The application interface 58 can be implemented in hardware, software, or a suitable combination of hardware and software, and which can be one or more software systems operating on a general-purpose processor platform, a digital signal processor platform, or other suitable processors.

In some examples, at various predefined periods and/or times, the UAV(s) 12, the base station 32, and/or the electronic device 48 may communicate with the server 50 through the network/cloud 52 to obtain the stored instructions, if any exist. Upon receiving the stored instructions, the UAV(s) 12, the base station 32, and/or the electronic device 48 may implement the instructions. In some instances, the UAV(s) 12, the base station 32, and/or the electronic device 48 can send event-related data to the server 50 for storage in the data store 54. This collection of event-related data can be accessed by any number of users, the UAV(s) 12, the base station 32, and/or the electronic device 48 to assist with application processes.

In some instances, the electronic device 48 may also access the server 50 to obtain information related to stored events. The electronic device 48 may be a mobile device, tablet computer, laptop computer, desktop computer, watch, virtual reality device, television, monitor, or any other computing device or another visual device.

In various embodiments, the data used by the UAV(s) 12, the base station 32, the electronic device 48, the remote server 50, the data store 54, the application 56, the application interface 58, and/or any other component described herein for any purpose may be based on data provided by the one or more sensors and/or third-party data that may be converted into comparable data that may be used independently or in conjunction with data collected from the one or more sensors.

In various examples, the server 50 may implement machine learning engine methods and algorithms that utilize one or several machine learning techniques including, for example, decision tree learning, including, for example, random forest or conditional inference trees methods, neural networks, support vector machines, clustering, and Bayesian networks. These algorithms can include computer-executable code that can be retrieved by the server 50 through the network/cloud 52 and may be used to generate a predictive evaluation of the field 14. In some instances, the machine learning engine may allow for changes to a map of the field 14 to be updated without human intervention.

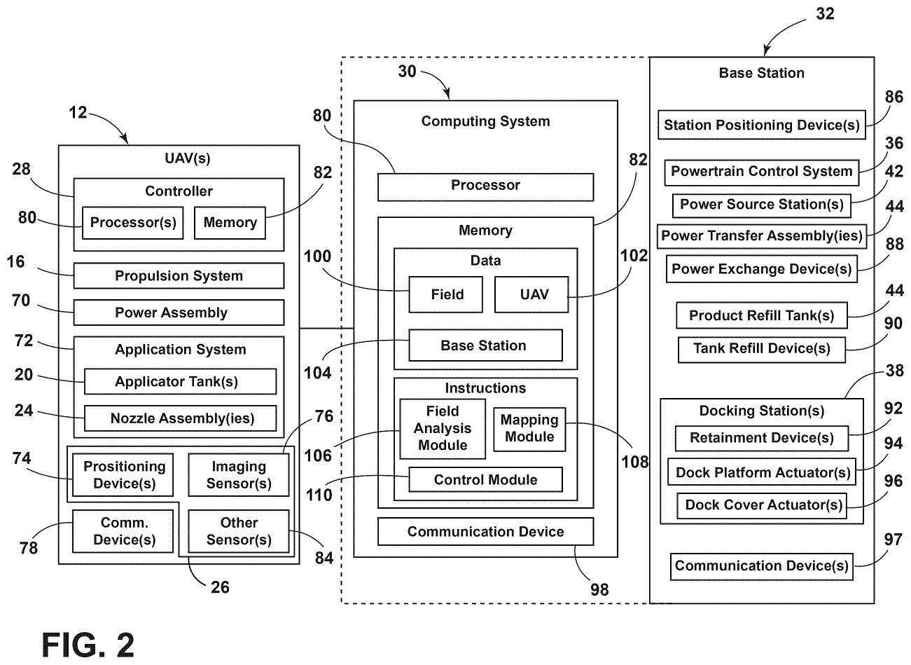

Referring now to FIG. 2, a schematic view of components of the system 10 of FIG. 1 is illustrated in accordance with aspects of the present subject matter. Particularly, the system 10 is described in FIG. 2 with reference to one of the UAVs 12 and the base station 32 from FIG. 1. It should be appreciated, however, that, in other embodiments, the disclosed system 10 may have any other suitable system configuration or architecture and/or may incorporate any other suitable components and/or combination of components that generally allow the system 10 to function as described herein.

As described above with reference to FIG. 1, the system 10 may include one or more UAVs, such as the UAVs 12, where each UAV 12 may include and/or be configured to support various components, such as one or more computing devices, propulsion systems, power assemblies, application systems, and sensors. For instance, the UAV 12 may include the on-board computing device(s) 28, the propulsion system(s) 16, one or more power assemblies 70 (e.g., including the battery(ies) 18), one or more application systems 72 (e.g., including the product tank 20, the plumbing components 22, the nozzle assembly(ies) 24, etc.), the sensor(s) 26 (e.g., including one or more positioning devices 74, one or more imaging sensors 76, and/or one or more other sensors 84), and/or one or more communication devices 78.

In general, the UAV computing device 28 may correspond to any suitable processor-based device(s), such as a computing device or any combination of computing devices. Thus, in several embodiments, the UAV computing device 28 may include one or more processor(s) 80 and associated memory device(s) 82 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 82 of the UAV computing device 28 may generally comprise memory element(s) including, but not limited to, computer readable medium (e.g., random access memory (RAM)), computer readable non-volatile medium (e.g., a flash memory), a compact disc-read only memory (CD-ROM), a magneto-optical disk (MOD), a digital versatile disc (DVD) and/or other suitable memory elements. Such memory device(s) 82 may generally be configured to store suitable computer-readable instructions that, when implemented by the processor(s) 80, configure the UAV computing device 28 to perform various computer-implemented functions. It should be appreciated that the UAV computing device 28 may also include various other suitable components, such as a communications circuit or module, a network interface, one or more input/output channels, a data/control bus, and/or the like.

In several embodiments, the UAV computing device 28 may be configured to control the operation of one or more other components of the UAV 12. For instance, the UAV computing device 28 may be configured to control the propulsion system 16 of the UAV 12. For instance, as indicated above, the UAV computing device 28 may be configured to control the propulsion system 16 in a manner that allows the UAV 12 to be flown across a field 14 according to a predetermined or desired flight plan. In this regard, the propulsion system 16 may include any suitable components that allow for the trajectory, speed, and/or altitude of the UAV 12 to be regulated, such as one or more power sources (e.g., one or more batteries 18 of the power assembly 70), one or more drive sources (e.g., one or more motors and/or engines), and one or more lift/steering sources (e.g., propellers, blades, wings, rotors, and/or the like). Similarly, as indicated above, the UAV computing device 28 may be configured to control the application system 72 in a manner that allows the UAV 12 to selectively apply agricultural product to the field as the UAV 12 performs the flight plan. In this regard, the application system 72 may include any suitable components that allow for the dispensing of agricultural product by the UAV 12 to be regulated, such as the applicator tank(s) 20, the plumbing component(s) 22, the nozzle assembly(ies) 24, etc.

In various embodiments, the computing device 28 may be configured to monitor the position of the UAV 12 to control the propulsion system 16 and/or the application system 72. For instance, the positioning device(s) 74 may be configured to determine the exact location of the UAV 12 within the field 14 using a satellite navigation position system (e.g. a GPS, a Galileo positioning system, a Global Navigation satellite system (GLONASS), a BeiDou Satellite Navigation and Positioning system, and/or the like), and/or a dead reckoning device. In such embodiments, the location determined by the positioning device(s) 74 may be transmitted to the UAV computing device 28 (e.g., in the form of coordinates) and stored within the memory 82 for subsequent processing and/or analysis. By monitoring the location of the UAV 12 as a pass is being made across the field 14, the sensor data acquired via the imaging sensor(s) 76 may be geo-located within the field 14. For instance, in various embodiments, the location coordinates derived from the positioning device(s) 74 and the sensor data generated by the imaging sensor(s) 76 may both be time-stamped. In such an embodiment, the time-stamped data may allow the sensor data to be matched or correlated to a corresponding set of location coordinates received or derived from the positioning device(s) 74, thereby allowing a field map to be generated that locates various objects (e.g., targets, weeds, crops, landmarks, etc.) within the field 14 relative to one another.

It should be appreciated that the UAV 12 may also include any other suitable components. For instance, in addition to the imaging sensor(s) 76, the UAV 12 may also include various other sensors 84, such as one or more inertial measurement units for monitoring the orientation of the UAV 12 and/or one or more altitude sensors for monitoring the pose of the UAV 12 relative to the ground. As used herein, “pose” includes the position and orientation of an object, such as the position and orientation of a vehicle, in some reference frame. Moreover, the UAV 12 may include a communications device(s) 78 to allow the UAV computing device 28 to be communicatively coupled to one or more other system components. The communications device 78 may, for example, be configured as a wireless communications device (e.g., an antenna or transceiver) to allow for the transmission of wireless communications between the UAV computing device 28 and one or more other remote system components.

Moreover, as described above with reference to FIG. 1, the system 10 may include or more base stations, such as the base station 32, where each base station 32 may include and/or be configured to support various components, such as one or more computing devices, propulsion systems, UAV refueling-related components, and sensors. For instance, the base station 32 may include the base station computing devices or system(s) 30, the powertrain control system(s) 36, and one or more station positioning device(s) 86. Moreover, the base station 32 may include UAV refueling-related components, such as one or more power-related refueling components (e.g., the powertrain control system(s) 36, the power source station(s) 42, the power transfer assembly(ies) 44, one or more power exchange devices 88, and/or the like), one or more agricultural product-related refueling components (e.g., the refill tanks 40, one or more tank refill device(s) 90, and/or the like), and one or more docking station control components (e.g., one or more retainment devices 92, one or more dock platform actuators 94, one or more dock cover actuators 96, and/or the like). Additionally, while not shown, the base station 32 may include one or more other devices.

Similar to the UAV computing device(s) 28 described above, the base station computing device(s) 30 may correspond to any suitable processor-based device(s), such as a computing device or any combination of computing devices. Thus, in several embodiments, the base station computing device(s) 30 may include one or more processor(s) 80 and associated memory device(s) 82 configured to perform a variety of computer-implemented functions. Additionally, the memory device(s) 82 of the base station 32 may generally be configured to store suitable computer-readable instructions that, when implemented by the processor(s) 80, configure the base station computing device(s) 30 to perform various computer-implemented functions. It should be appreciated that the base station computing device(s) 30 may also include various other suitable components, such as a communications circuit or module, a network interface, one or more input/output channels, a data/control bus, and/or the like.

In several embodiments, the base station computing device(s) 30 may be configured to control the operation of one or more other components of the base station 32. For instance, the base station computing device(s) 30 may be configured to control the powertrain control system 36 of the base station 32. For instance, the base station 32 may be configured to control the powertrain control system 36 in a manner that allows the base station 32 to move. In this regard, the powertrain control system 36 may include any suitable components that allow for the trajectory, speed, and/or the like of the base station 32 to be regulated, such as one or more power sources, one or more drive sources (e.g., one or more motors and/or engines), and/or one or more steering sources. Similarly, as indicated above, the base station computing device(s) 30 may be configured to control the power-related refueling component(s), the agricultural product-related refueling component(s), and/or the docking stations control component(s) in a manner that supports refilling/refueling servicing of the UAVs 12.

In various embodiments, the base station computing device(s) 30 may be configured to monitor the position of the base station 32 to control the propulsion system 16. For instance, the positioning device(s) 86 of the base station 32, similar to the positioning device(s) 74, may be configured to determine the exact location of the base station 32 relative to the field 14 using a satellite navigation position system (e.g. a GPS, a Galileo positioning system, a Global Navigation satellite system (GLONASS), a BeiDou Satellite Navigation and Positioning system, and/or the like), and/or a dead reckoning device. In such embodiments, the location determined by the positioning device(s) 86 may be transmitted to the base station computing device(s) 30 (e.g., in the form of coordinates) and stored within the memory 82 for subsequent processing and/or analysis. In some instances, the location of the base station 32 may be monitored with respect to the location of one or more of the UAVs 12.

It should be appreciated that the base station 32 may also include any other suitable components. For instance, the base station 32 may also include various other sensors, such as one or more inertial measurement units (not shown) for monitoring the orientation of the base station 32. As used herein, “pose” includes the position and orientation of an object, such as the position and orientation of a vehicle, in some reference frame. Moreover, the base station 32 may include a communications device(s) 97 to allow the base station computing device(s) 30 to be communicatively coupled to one or more other system components. The communications device 97 may, for example, be configured as a wireless communications device (e.g., an antenna or transceiver) to allow for the transmission of wireless communications between the base station computing device(s) 30 and one or more other remote system components.

As further shown in FIG. 2, base station computing device(s) 30 may additionally be configured to be in communication with one or more components of the UAV 12 to allow data to be transferred between the UAV 12 and the base station computing device(s) 30, such as sensor data collected via the positioning device(s) 74, the imaging sensor(s) 76, and/or the like. For instance, as shown in FIG. 2, the base station computing device(s) 30 may also include a communications device(s) 98 to allow for the base station computing device(s) 30 to communicate with the UAV(s) 12. For instance, one or more communicative links or interfaces (e.g., one or more data buses) may be provided between the communications device(s) 98 and the UAV(s) 12.

In various embodiments, the memory device(s) 82 of the base station computing device(s) 30 may include one or more databases for storing information. For instance, as shown in FIG. 2, the memory device(s) 82 may include a field database 100 storing data indicative of field conditions, topology, and/or the like, such as data received from the imaging sensor(s) 76 during a pre-emergence condition (e.g., prior to a seed planting operation in the field 14 or following such operation but prior to the emergence of the plants), during a growing condition (following emergence of plants, prior to harvesting), and/or the like, and/or from any other suitable source. The image data received may be raw or processed data of one or more portions of the field 14. The field database 100 may also store various forms of data that a related to identified objects within and/or proximate to the field 14. For example, the objects may include targets and/or landmarks that may be used to relocate the targets during a subsequent operation.

In one or more embodiments, the memory device(s) 82 of the base station computing device(s) 30 may include a UAV database 102 for storing data associated with the UAV(s) 12. For instance, the UAV database 102 may include information associated with the configuration of the UAVs 12 (e.g., fill tank capacity, battery requirements, and/or the like), the position data from the positioning device(s) 74 on the UAV(s) 12, data indicative of fill level(s) of the applicator tank(s) 20 on the UAV(s) 12, data indicative of a power level of the power assembly 70 (e.g., estimated remaining battery life of the battery(ies) 18) on the UAV(s) 12, and/or the like.

Similarly, the memory device(s) 82 of the base station computing device(s) 30 may include a base station database 104 for storing data associated with the base station(s) 32. For instance, the base station database 104 may include information with the configuration of the base station 32 (e.g., number of docking stations 38, capacity of the refill tank(s) 40, capacity of the power source station 42, and/or the like), the position data generated by the station positioning device(s) 86 of the base station(s) 32, data indicative of fill level(s) of the refill tank(s) 40 of the base station(s) 32, data indicative of the status of battery(ies) 18 and/or fill level of fuel at the power source station 42, data indicative of the status of the docking station(s) 38, and/or the like.

Referring still to FIG. 2, in several embodiments, the instructions stored within the memory device(s) 82 of the base station computing device(s) 30 may be executed by the processor(s) 80 to implement a field analysis module 106. In general, the field analysis module 106 may be configured to analyze the field data 100 to allow the base station computing device(s) 30 to detect/identify the type of various objects in the field 14. In this regard, the base station computing device(s) 30 may include any suitable image processing algorithms stored within its memory 82 or may otherwise use any suitable image or data processing techniques on the field data 100. For instance, in some embodiments, the base station computing device(s) 30 may be able to distinguish between weeds and emerging/standing crops. Additionally, or alternatively, in some embodiments, the base station computing device(s) 30 may be configured to distinguish between weeds and emerging/standing crops, such as by identifying crop rows of emerging/standing crops and then inferring that plants positioned between adjacent crop rows are weeds.

Moreover, the instructions stored within the memory device(s) 82 of the base station computing device(s) 30 may be executed by the processor(s) 80 to implement a mapping module 108 that is configured to generate one or more maps of the field 14 based on the field data 100. It should be appreciated that, as used herein, a “map” may generally correspond to any suitable dataset that correlates data to various locations within a field 14. Thus, for example, a map may simply correspond to a data table that correlates field data to various locations within the field 14 or may correspond to a more complex data structure, such as a geospatial numerical model that can be used to identify various objects in the field data and determine a position of each object within the field 14, which may, for instance, then be used to generate a graphically displayed map or visual indicator.

Referring still to FIG. 2, in some embodiments, the instructions stored within the memory 82 of the base station computing device(s) 30 may also be executed by the processor(s) 80 to implement a control module 110. In general, the control module 110 may be configured to generate flight plan instructions and/or application instructions for performing an agricultural spraying operation with the UAV(s) 12. More particularly, the control module 110 may utilize the field data 100, the UAV data 102, and/or the base station data 104 to generate an efficient flight plan and associated application instructions that reduces the amount of time for the UAV(s) 12) to navigate a field with one or more no-spray zones between at least two spray zones.

When performing an agricultural spraying operation with conventional agricultural sprayers that move on the ground in a field that has one or more no-spray zones between spray zones, depending on the no-spray zone configuration, the conventional sprayers may not be taken across the no-spray zone. For instance, the no-spray zone may extend between the edges of two fields, may be a run-off area that dips significantly in elevation between the spray zones, may include a wall or fence between the spray zones, may include trees between the spray zones, may include a building and/or road between the spray zones, and/or the like. As such, the conventional sprayers often turn around at the boundary of the no-spray zone to avoid such area. However, UAV applicators (e.g., UAV(s) 12) may not be affected by such ground-level limitations.

As such, in accordance with aspects of the present subject matter, the control module 110 may use the field data 100, the UAV data 102, the base station data 104, the output(s) of the field analysis module 106, and/or the output of the mapping module 108 to identify and/or any other suitable information received to generate flight plans and application instructions. For instance, the control module 110 may identify spray zones and no-spray zones within a field. In some instances, the control module 110 may determine the boundaries of such spray zones and no-spray zones (e.g., using data and/or image analysis techniques as part of the field analysis and/or mapping modules 106, 108) and/or may receive data indicative of the spray zones and/or the no-spray zones from an operator. Thereafter, the control module 110 may determine the most efficient (e.g., shortest and/or quickest) path(s) for the UAV(s) 12 to fly across an entirety of the spray zones. Generally, the most efficient path(s) will require fewer turns and/or the least amount of commute distance to the base station 32 for servicing the UAV(s) 12 (e.g., refilling of agricultural product and/or recharging/swapping of power source).

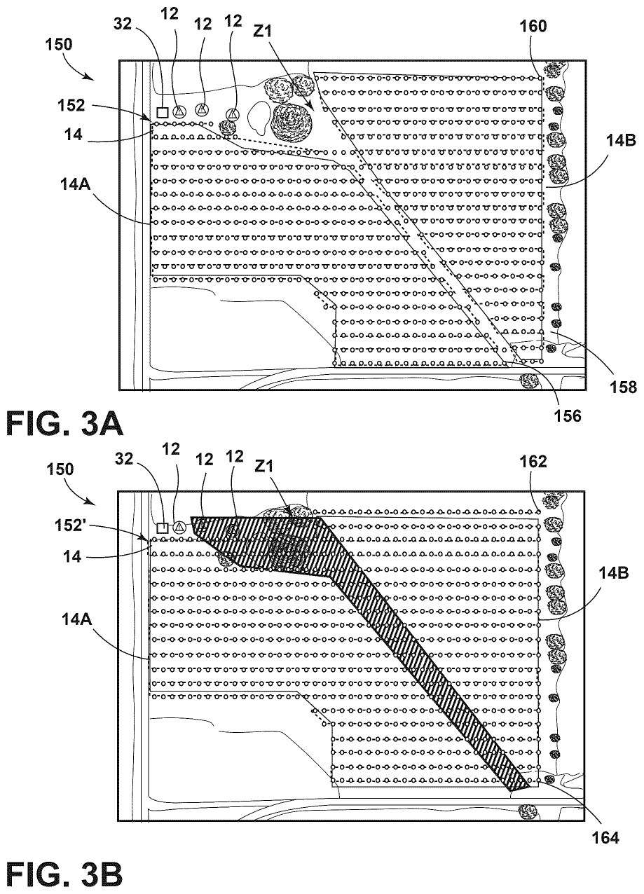

For example, as shown in FIG. 3A, a field map 150 for a field (e.g., the field 14) is shown overlaid with a flight plan 152 for the UAV(s) 12. The field 14 includes two spray areas (e.g., a first spray zone 14A and a second spray zone 14B) which are separated by a no-spray zone Z1. The flight plan 152 includes a first continuous path in the first spray zone 14A, the first continuous path extending between a first starting point 154 and a first ending point 156. The first continuous path includes a plurality of passes across the first spray zone 14A, where directly adjacent passes are separated by turns. For instance, in the illustrated embodiment, each of the plurality of passes of the first continuous path extends substantially linearly from the left side of the first spray zone 14A toward the right side of first spray zone 14A, where directly adjacent passes are separated alternatingly by turns at the left side of the first spray zone 14A or the right side of the first spray zone 14A, adjacent or within the no-spray zone Z1. Similarly, the flight plan 152 includes a second continuous path in the second spray zone 14B, the second continuous path extending between a second starting point 158 and a second ending point 160, where the second continuous path also includes a plurality of passes across the field 14 separated by turns. For instance, in the illustrated embodiment, each of the plurality of passes of the second continuous path extends substantially linearly from the left side of the second spray zone 14B to the right side of the second spray zone 14B, where directly adjacent passes are separated alternatingly by turns at the left side of the second spray zone 14B (adjacent or within the no-spray zone Z1) or at the right side of the second spray zone 14B.

It should be appreciated that, while the flight plan 152 is shown as having a single continuous path covering the entirety of the first spray zone 14A and a single continuous path covering the entirety of the second spray zone 14B, in a situation where multiple UAVs 12 are being used, the flight plan 152 may be provided with multiple paths (with respective start and end points) for each spray zone, where each of the multiple paths extends across one or more of the passes in the flight plan 152 such that the field 14 may be simultaneously sprayed by multiple UAVs 12. It should additionally be appreciated that the paths for the multiple UAVs 12 may be laid out such that there is no overlap between the paths of the multiple UAVs 12, unless required for the prescribed application amounts. Moreover, it should be appreciated that while the field 14 is only shown as having one no-spray zone Z1 and the two spray zones 14A, 14B, the field 14 may have any other suitable number of no-spray zones, such as two or more no-spray zones, such that the field may also have more than two spray zones. Additionally, it should be appreciated that while the no-spray zone Z1 is illustrated as completely separating the two spray zones 14A, 14B, the no-spray zone(s) Z1 may, in some instances, only separate part of the spray zones. For instance, the first spray zone 14A extends across about 18 horizontal passes and the second spray zone 14B extends across about 21 horizontal passes in FIG. 3A, where the no-spray zone Z1 separates the horizontal passes of the first spray zone 14A from the horizontal passes of the second spray zone 14B, however, in other instances, the no-spray zone Z1 may instead only separate some (e.g., one, two, three, or more) of the horizontal passes of the first spray zone 14A from the horizontal passes of the second spray zone 14B.

FIG. 3B shows the field map 150 for the field 14 overlaid with a different flight plan 152′ generated in accordance with aspects of the present subject matter. Particularly, the flight plan 152′ includes a continuous path between a starting point 162 and an ending point 164, where the continuous path covers both the first spray zone 14A and the second spray zone 14B. More particularly, one or more of the passes of the continuous path of the flight plan 152′ extend across the first spray zone 14A, the second spray zone 14B, and the no-spray zone Z1 such that no turns are necessary at the no-spray zone Z1. For instance, one or more of the passes of the flight plan 152′ extends substantially linearly from the left side of the first spray zone 14A, through the no-spray zone Z1, to the right side of the second spray zone 14B, where turns between directly adjacent passes occur at the left side of the first spray zone 14A or the right side of the second spray zone 14B. As such, compared to the flight plan 152 in FIG. 3A, the flight plan 152′ of FIG. 3B significantly reduces the number of turns to be taken by the UAV(s) 12 as the turns between the first and second spray zones 14A, 14B are no longer needed. For instance, the flight plan 152′ of FIG. 3B requires about half of the turns of the flight plan 152 of FIG. 3A, which equates to about fifteen less turns than the flight plan 152 of FIG. 3A. Thus, the flight plan 152′ of FIG. 3B may be undertaken with significantly less time than the flight plan 152 of FIG. 3A, which increases the productivity of the UAV(s) 12.

It should be appreciated that, while the flight plan 152′ is shown as having a single continuous path covering the entirety of the field 14, in a situation where multiple UAVs 12 are being used, the flight plan 152′ may be provided with multiple paths (with respective start and end points), where each of the multiple paths extends across one or more of the passes in the flight plan 152′ such that the field 14 may be simultaneously sprayed by multiple UAVs 12. It should additionally be appreciated that the paths for the multiple UAVs 12 may be laid out such that there is no overlap between the paths of the multiple UAVs 12, unless required for the prescribed application amounts. Again, it should be appreciated that while the field 14 is only shown as having one no-spray zone Z1 and the two spray zones 14A, 14B, the field 14 may have any other suitable number of no-spray zones, such as two or more no-spray zones, such that the field may also have more than two spray zones. Additionally, it should again be appreciated that while the no-spray zone Z1 is illustrated as completely separating the two spray zones 14A, 14B, the no-spray zone(s) Z1 may, in some instances, only separate part of the spray zones.

Referring back to FIG. 2, in some instances, the control module 110 may determine whether or not to fly over the no-spray zone for a particular pass. For instance, the flight plan generated by the control module 110 may include a combination of passes that turn at the no-spray zone and passes that fly over the no-spray zone, depending on different features along the no-spray zone. For example, if the control module 110 determines that the no-spray zone includes features that are significantly taller than the features in the spray zones, such as a dense grouping of tall trees, or that the spray zones are at significantly different elevations, the control module 110 may determine whether it is faster to turn back to the next row in a spray zone or to fly over the no-spray zone to reach the next spray zone when approaching such feature(s). If the control module 110 determines that a time to turn at the no-spray zone is less than a time to fly over the no-spray zone (such as at a particular feature(s)), the control module 110 may route the flight plan to turn at the no-spray zone (e.g., at least at the particular feature(s)). For example, if it would take ten seconds for the UAV(s) 12 to fly over the no-spray zone to reach the next spray area, but only six seconds to turn back to the next row or pass, the control module 110 may include a turn at the feature(s) instead of the fly-over. Conversely, if the control module 110 determines that a time to turn at the no-spray zone is greater than a time to fly over the no-spray zone (such as at a particular feature(s)), the control module 110 may route the flight plan to fly over the no-spray zone (e.g., at least at the particular feature(s)). For example, if it would take only five seconds for the UAV(s) 12 to fly over the no-spray zone to reach the next spray area, but seven seconds to turn back to the next row or pass, the control module 110 may include fly-over the features in the no-spray zone instead of turn at the feature(s).

In some instances, the time required to turn may be determined based at least in part on the speed of the UAV(s) 12, the distance to turn between two passes or rows, and/or the like. Similarly, the time required to fly over the no-spray zone may be determined based at least in part on the speed of the UAV(s) 12 (e.g., in changing elevation (flying up or down), in lateral movement along a pass (forward/back), and/or the like), the distance to travel to reach the next spray area (e.g., total elevation change and/or a total lateral distance between the spray areas), and/or the like. In some instances, such times may be predetermined and stored in the memory 82 of the base station computing device(s) 30.

Moreover, the control module 110 may generate application instructions for controlling the application system(s) 72 of the UAV(s) 12. For instance, the application instructions may determine when and/or where the UAV(s) 12 will start and stop spraying. For example, the application instructions may indicate when and/or where a UAV(s) 12 should or should not spray when approaching the no-spray zone(s) to avoid spraying within the no-spray zone(s), such as based on the location of the UAV(s) 12 relative to the no-spray zone boundary, the speed and/or direction of the UAV(s) 12, a height of the UAV(s) 12 above the field 14, wind speed and/or direction at the field 14, and/or the like. Similarly, the instructions may indicate when and/or where a UAV(s) should begin spraying when approaching a spray zone(s) to avoid skipping areas within the spray zone(s) near the no-spray zone(s), such as based on the location of the UAV(s) 12 relative to the spray zone boundary, the speed and/or direction of the UAV(s) 12, a height of the UAV(s) 12 above the field 14, wind speed and/or direction at the field 14, and/or the like. Moreover, the instructions may indicate when and/or where a UAV(s) should spray when within the spray zone(s) to spray objects identified by the field analysis module 106 and/or mapped by the mapping module 108, such as for selectively spraying, based on the location of the UAV(s) 12 relative to the spray zone boundary (ies), the speed and/or direction of the UAV(s) 12, a height of the UAV(s) 12 above the field 14, wind speed and/or direction at the field 14, and/or the like.

Additionally, it should be appreciated that, in some embodiments, the control module 110 may be configured to divide the flight plan across different UAVs 12. For instance, based on the tank capacity and/or power capacity of the UAVs 12, the control module 110 may determine how to divide the flight plan to minimize the number of times that the UAVs 12 need to return to the base station 32 to complete the spraying operation. As such, each of the UAVs 12 may be assigned different starting points and ending points in the field 14.

The operation of the UAV(s) 12 may then be controlled to perform the spraying operation based at least in part on the flight plan and/or the application instructions generated by the control module 110. In some instances, the operation of the UAV(s) 12 (e.g., of the propulsion system 16 and/or application system 72) may be automatically controlled based at least in part on the flight plant and/or the application instructions generated by the control module 110. However, in other embodiments, a user interface associated with the system 10 may be used to display or otherwise indicate the flight plan and/or the application instructions. In such embodiments, an operator may then accept the flight plan and/or the application instructions for the system 10, where upon receipt of an indication of acceptance, the control module 110 may then automatically control the UAV(s) 12 to perform the spraying operation.

As such, the flight plan and related application instructions generated by the control module 110 significantly reduce the amount of time for performing an agricultural spraying operation with the UAVs 12, while improving compliance with no-spray zones.

It should be appreciated that, while the field analysis module 106, the mapping module 108, and control module 110 are discussed as being performed by the base station computing device(s) 30 as part of the base station 32, such modules may instead, or additionally, be performed by computing device(s) corresponding to a stand-alone component or may be incorporated into or form part of a separate component or assembly of components. For example, the computing system(s) 30 performing such modules may be incorporated into or form part of the UAV(s) 12 and/or the cloud computing system 46.

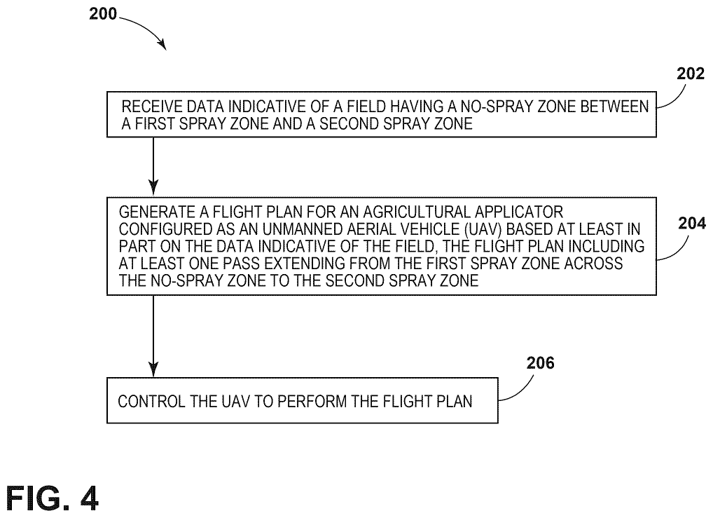

Referring now to FIG. 4, a flow diagram of some embodiments of a method 200 for performing an agricultural spraying operation with an agricultural applicator is illustrated in accordance with aspects of the present subject matter. In general, the method 200 will be described herein with reference to the one or more UAVs, and the system 10 described above with reference to FIGS. 1-3B. However, it will be appreciated by those of ordinary skill in the art that the disclosed method 200 may generally be utilized with any suitable agricultural vehicles and/or may be utilized in connection with a system having any other suitable system configuration. In addition, although FIG. 4 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 4, at (202), the method 200 can include receiving data indicative of a field having a no-spray zone between a first spray zone and a second spray zone. For instance, as described above, the computing system 30 may receive data indicative of a field 14 having a no-spray zone Z1 between a first spray zone 14A and second spray zone 14B. The data may be the field data 100, an output of the field analysis module 106, an output of the mapping module 108, and/or received in any other suitable manner (e.g., input by an operator).

Moreover, at (204), the method 200 may include generating a flight plan for an agricultural applicator configured as an unmanned aerial vehicle (UAV) based at least in part on the data indicative of the field, the flight plan including at least one pass extending from the first spray zone across the no-spray zone to the second spray zone. For example, as discussed above, the computing system 30 may generate a flight plan (e.g., the flight plan 152′) for an agricultural applicator configured as a UAV (e.g., UAV 12) having an applicator tank 20 for holding agricultural product configured to be dispensed within the spray zones, where the flight plan is based at least in part on the data indicative of the field, and where the flight plan includes at least one pass extending from the first spray zone 14A across the no-spray zone Z1 to the second spray zone 14B.

Additionally, at (206), the method 200 may include controlling the UAV to perform the flight plan. For instance, the computing system may control the UAV 12 to perform the flight plan such that the UAV 12 flies across at least one continuous pass extending across the first spray zone 14A and the no-spray zone Z1 to the second spray zone 14B.

In various examples, the method 200 may implement machine learning methods and algorithms that utilize one or several machine learning techniques including, for example, decision tree learning, including, for example, random forest or conditional inference trees methods, neural networks, support vector machines, clustering, and Bayesian networks. These algorithms can include computer-executable code that can be retrieved by the computing system and/or through a network/cloud and may be used to evaluate and update the models for performing a spraying operation with the UAV(s) 12. In some instances, the machine learning engine may allow for changes to the models for performing a spraying operation with the UAV(s) 12 to be performed without human intervention.

It is to be understood that the steps of any method disclosed herein may be performed by a computing system upon loading and executing software code or instructions that are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions that are tangibly stored on a tangible computer-readable medium. The computing system loads the software code or instructions via a direct interface with the computer-readable medium or via a wired and/or wireless network. Upon loading and executing such software code or instructions by the computing device, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A method for performing an agricultural spraying operation, the method comprising:
receiving, with a computing system, data indicative of a field having a no-spray zone between spray zones, the spray zones including a first spray zone and a second spray zone;
generating, with the computing system, a flight plan across the field for an agricultural applicator based at least in part on the data indicative of the field, the agricultural applicator being configured as an unmanned aerial vehicle (UAV) having an applicator tank for holding agricultural product configured to be dispensed within the spray zones, the flight plan including at least one pass extending from the first spray zone across the no-spray zone to the second spray zone; and
controlling, with the computing system, the UAV to perform the flight plan.

2. The method of claim 1, further comprising:
generating, with the computing system, application instructions based at least in part on the data indicative of the field and the flight plan, the application instructions indicating when the agricultural product should be dispensed from the UAV to spray within the first and second spray zones; and
controlling, with the computing system, the UAV to dispense the agricultural product based at least in part on the application instructions.

3. The method of claim 2, wherein the application instructions further indicate when the agricultural product should not be dispensed from the UAV to avoid spraying within the no-spray zone.

4. The method of claim 2, wherein generating the application instructions comprises determining the application instructions based at least in part on one or more of a speed of the UAV, a height of the UAV above the field, or a wind speed at the field.

5. The method of claim 1, wherein generating the flight plan comprises:
determining a time to turn at a boundary of the no-spray zone;
determining a time to fly the UAV from the first spray zone, across the no-spray zone, to the second spray zone;
generating the flight plan with the at least one pass when the time to fly the UAV from the first spray zone, across the no-spray zone, to the second spray zone is less than the time to turn at the boundary of the no-spray zone; and
generating the flight plan with one or more passes having a turn at the no-spray zone when the time to fly the UAV from the first spray zone, across the no-spray zone, to the second spray zone is greater than the time to turn at the boundary of the no-spray zone.

6. The method of claim 5, wherein determining the time to turn at the boundary of the no-spray zone comprises determining the time to turn at the boundary of the no-spray zone based at least in part on one or more of a speed of the UAV or a distance for performing the turn.

7. The method of claim 5, wherein determining the time to fly the UAV from the first spray zone, across the no-spray zone, to the second spray zone comprises determining the time to fly the UAV from the first spray zone, across the no-spray zone, to the second spray zone based at least in part on one or more of a speed of the UAV, a total elevation change from the first spray zone, across the no-spray zone, to the second spray zone, or a total lateral distance from the first spray zone, across the no-spray zone, to the second spray zone.

8. The method of claim 1, wherein controlling the UAV to perform the flight plan comprises automatically controlling the UAV to perform the flight plan.

9. The method of claim 1, further comprising presenting, with the computing system, the flight plan via a user interface,
wherein controlling the UAV to perform the flight plan comprises automatically controlling the UAV to perform the flight plan upon receipt of an operator input indicative of accepting the flight plan in response to presenting the flight plan via the user interface.

10. A system for performing an agricultural spraying operation, the system comprising:
an agricultural applicator configured as an unmanned aerial vehicle (UAV), the UAV having an applicator tank for holding agricultural product;
a computing system communicatively coupled to the UAV, the computing system being configured to:
receive data indicative of a field having a no-spray zone between spray zones, the spray zones including a first spray zone and a second spray zone; and
generate a flight plan across the field for the UAV based at least in part on the data indicative of the field, the UAV being configured to dispense the agricultural product within the spray zones when following the flight plan, the flight plan including at least one pass extending from the first spray zone across the no-spray zone to the second spray zone.

11. The system of claim 10, wherein the computing system is further configured to generate application instructions based at least in part on the data indicative of the field and the flight plan, the application instructions indicating when the agricultural product should be dispensed from the UAV to spray within the first and second spray zones.

12. The system of claim 11, wherein the computing system is further configured to control the UAV to dispense the agricultural product based at least in part on the application instructions.

13. The system of claim 11, wherein the application instructions further indicate when the agricultural product should not be dispensed from the UAV to avoid spraying within the no-spray zone.

14. The system of claim 11, wherein the computing system is configured to generate the application instructions further based at least in part on one or more of a speed of the UAV, a height of the UAV above the field, or a wind speed at the field.

15. The system of claim 10, wherein the computing system is configured to generate the flight plan by:
determining a time to turn at a boundary of the no-spray zone;
determining a time to fly the UAV from the first spray zone, across the no-spray zone, to the second spray zone;
generating the flight plan with the at least one pass when the time to fly the UAV from the first spray zone, across the no-spray zone, to the second spray zone is less than the time to turn at the boundary of the no-spray zone; and
generating the flight plan with one or more passes having a turn at the no-spray zone when the time to fly the UAV from the first spray zone, across the no-spray zone, to the second spray zone is greater than the time to turn at the boundary of the no-spray zone.

16. The system of claim 15, wherein the computing system is configured to determine the time to turn at the boundary of the no-spray zone based at least in part on one or more of a speed of the UAV or a distance for performing the turn.

17. The system of claim 15, wherein the computing system is configured to determine the time to fly the UAV from the first spray zone, across the no-spray zone, to the second spray zone based at least in part on one or more of a speed of the UAV, a total elevation change from the first spray zone, across the no-spray zone, to the second spray zone, or a total lateral distance from the first spray zone, across the no-spray zone, to the second spray zone.

18. The system of claim 10, wherein the computing system is further configured to control the UAV to perform the flight plan.

19. The system of claim 18, wherein the computing system is configured to automatically control the UAV to perform the flight plan.

20. The system of claim 18, the computing system is further configured to present the flight plan via a user interface,
wherein the computing system is configured to automatically control the UAV to perform the flight plan upon receipt of an operator input indicative of accepting the flight plan in response to presenting the flight plan via the user interface.
